(19) United States
(12) Patent Application Publication
(10) Pub. No.: US 2025/0379368 A1
(43) Pub. Date: Dec. 11, 2025

(54) RADIO WAVE REFLECTOR

(71) Applicant: Alps Alpine Co., Ltd., Tokyo (JP)

(72) Inventors: Yuanzhu DOU, Miyagi-ken (JP); Lifei ZHENG, Tokyo (JP)

(21) Appl. No.: 19/312,972

(22) Filed: Aug. 28, 2025

Related U.S. Application Data
(63) Continuation of application No. PCT/JP2024/002023, filed on Jan. 24, 2024.

(30) Foreign Application Priority Data
Mar. 6, 2023 (JP) 2023-033934

(51) Int. Cl. H01Q 15/18

(52) U.S. Cl. CPC H01Q 15/18

(57) ABSTRACT

A radio wave reflector includes a first flat surface and first inclined surface that reflect radio waves. The first inclined surface is connected to at least part of the outer edges of the first flat surface and is inclined with respect to the first flat surface. The areas of the first flat surface and first inclined surface have a relationship in which the difference between the maximum value of the strengths of reflected waves from the first flat surface and that for the first inclined surface is equal to or smaller than a predetermined value. In an angular distribution of reflected waves with respect to a normal passing through the center of the first flat surface, the first inclined surface is inclined with respect to the first flat surface so that an overlap is formed between angular ranges in which their respective reflected waves have a predetermined strength or higher.

### CLAIM OF PRIORITY

This application is a Continuation of International Application No. PCT/JP2024/002023 filed on Jan. 24, 2024, which claims benefit of Japanese Patent Application No. 2023-033934 filed on Mar. 6, 2023. The entire contents of each application noted above are hereby incorporated by reference.

### BACKGROUND OF THE INVENTION

### 1. Field of the Invention

The present disclosure relates to a radio wave reflector.

### 2. Description of the Related Art

A conventional corner reflector features a recessed portion of square pyramid type provided on the surface of a sphere, the recessed portion reflecting incident electromagnetic waves or the like in the incident direction (see Japanese Unexamined Patent Application Publication No. 63-85504, for example).

With the conventional corner reflector, the recessed portion of square pyramid type is used to enable retroreflection in a wide range of incident angles. Thus, if, for example, the conventional reflector is used as a reflector in a radar system that detects a target by reflecting a radio wave, when a plurality of corner reflectors are placed in a narrow space, reflected waves from corner reflector adjacent to each other are recursively reflected. This may lead to mistaken detection of the target.

### SUMMARY OF THE INVENTION

In view of this, the present disclosure provides a radio wave reflector that enables radio waves to be reflected within a narrow angular range in a front direction.

A radio wave reflector according to the present disclosure includes a first flat surface that reflects a radio wave, and also includes a first inclined surface that is connected to at least part of the outer edges of the first flat surface, is inclined with respect to the first flat surface, and reflects a radio wave. The area of the first flat surface and the area of the first inclined surface have a relationship in which the difference between the maximum value of the strengths of reflected waves from the first flat surface and the maximum value of the strengths of reflected waves from the first inclined surface is equal to or smaller than a predetermined value. In an angular distribution of reflected waves with respect to a normal passing through the center of the first flat surface, the first inclined surface is inclined with respect to the first flat surface so that an overlap is formed between an angular range in which the reflected wave from the first flat surface has a predetermined strength or higher and an angular range in which the reflected wave from the first inclined surface has the predetermined strength or higher.

Accordingly, it is possible to provide a radio wave reflector that enables radio waves to be reflected within a narrow angular range in a front direction.

### BRIEF DESCRIPTION OF THE DRAWINGS embodiment;

FIG. 1A illustrates an example of the structure of a radio wave reflector in an

FIG. 1B also illustrates the example of the structure of the radio wave reflector in the embodiment;

FIG. 1C illustrates an example of an angular distribution of reflected waves from the radio wave reflector in the embodiment;

FIG. 1D is an enlarged view of part of FIG. 1C;

FIG. 2A illustrates an example of the structure of a radio wave reflector in a first variation of the embodiment;

FIG. 2B also illustrates the example of the structure of the radio wave reflector in the first variation of the embodiment;

FIG. 2C illustrates an example of an angular distribution of reflected waves from the radio wave reflector in the first variation of the embodiment;

FIG. 2D illustrates another example of an angular distribution of reflected waves from the radio wave reflector in the first variation of the embodiment;

FIG. 3A illustrates an example of the structure of a radio wave reflector in a second variation of the embodiment:

FIG. 3B illustrates another example of the structure of the radio wave reflector in the second variation of the embodiment;

FIG. 4A illustrates an example of the structure of a radio wave reflector in another variation of the embodiment;

FIG. 4B illustrates an example of the structure of a radio wave reflector in another variation of the embodiment;

FIG. 4C illustrates an example of the structure of a radio wave reflector in another variation of the embodiment; and

FIG. 4D illustrates an example of the structure of a radio wave reflector in another variation of the embodiment.

### DESCRIPTION OF THE PREFERRED EMBODIMENTS

An embodiment to which a radio wave reflector of the present disclosure is applied will be described below. In the descriptions below, like members will be denoted by like reference characters and overlapping descriptions may be omitted.

The description below is based on an XYZ coordinate system. A direction parallel to the X axis is the X direction. A direction parallel to the Y axis is the Y direction. A direction parallel to the Z axis is the Z direction. These directions are mutually orthogonal. The XYZ coordinate system is an example of an orthogonal coordinate system. Viewing in an XY plane will refer to front view. In the description below, for easy understanding of the structure, the length, bulkiness, thickness, and the like of each portion may be indicated by being exaggerated. The terms “parallel”, “right angles”, “orthogonal”, “horizontal”, “perpendicular” “above”, “below”, and other similar words will allow incorrectness to the extent that effects of the embodiment are not lost.

### Embodiment

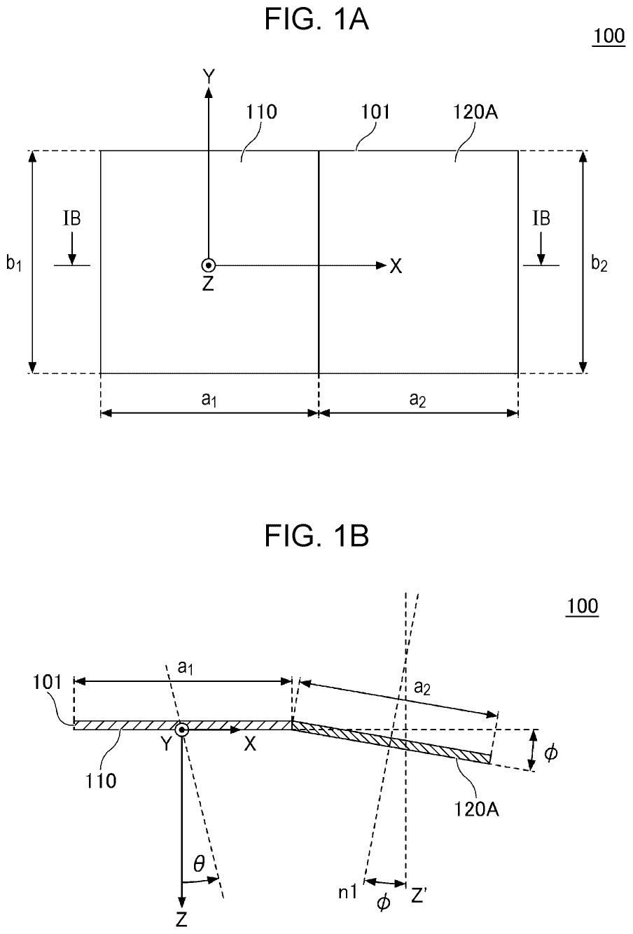

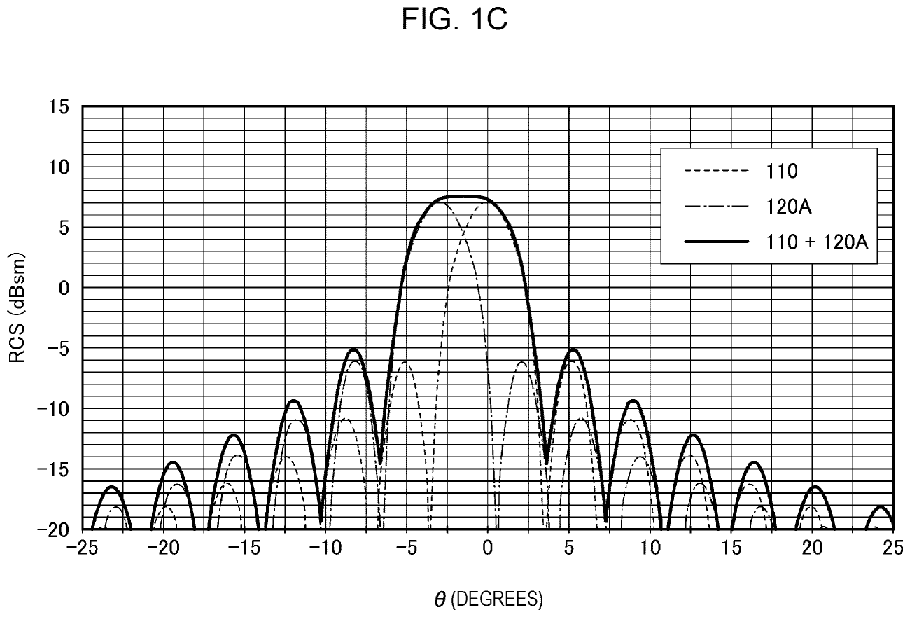

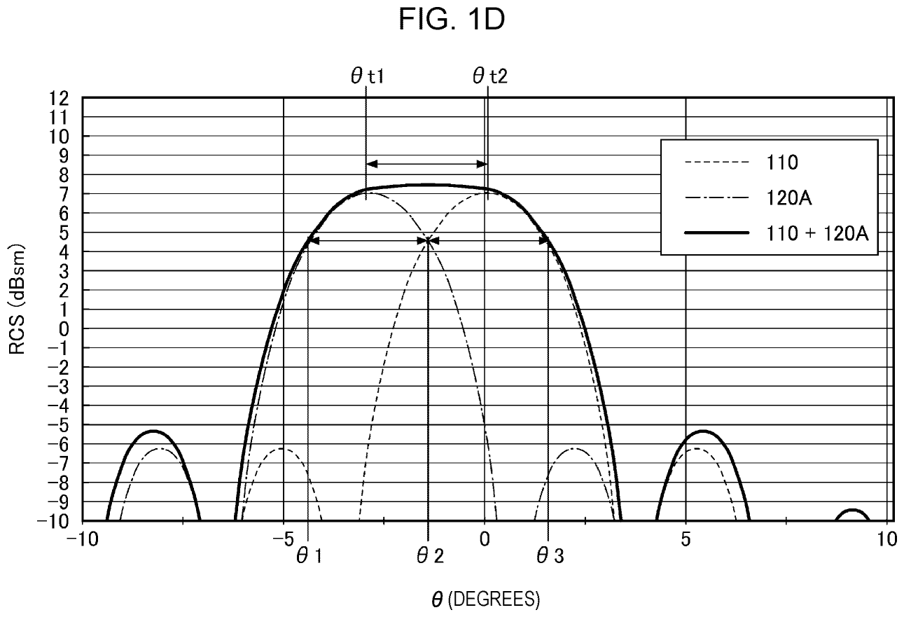

FIGS. 1A and 1B illustrate an example of the structure of a radio wave reflector 100 in an embodiment. FIG. 1A is a front view, and FIG. 1B illustrates an example of the structure at the cross section along line IB-IB in FIG. 1A.

The radio wave reflector 100 includes a base 101, a first flat surface 110, and a first inclined surface 120A. The radio wave reflector 100 reflects radio waves at the first flat surface 110 and first inclined surface 120A so that these radio waves can be reflected in a narrow angular range in the front direction.

Here, the XYZ coordinate system will be defined so that the origin of the XYZ coordinate system is taken as the center of the first flat surface 110, the first flat surface 110 is parallel to an XY plane, and a normal passing through the center of the first flat surface 110 matches the Z axis. That is, the first flat surface 110 is included in an XY plane. The front direction of the radio wave reflector 100 is the Z direction. The front direction of the radio wave reflector 100 matches the extending direction of the normal of the first flat surface 110. The front direction of the radio wave reflector 100 is defined by the extending direction of the normal of the first flat surface 110. FIG. 1B is a sectional view of the radio wave reflector 100 illustrated in FIG. 1A, as taken along an XZ plane.

The narrow angular range in the front direction is a range defined by a narrow angle centered around the normal (Z axis) passing through the center of the first flat surface 110. Specifically, the narrow angular range in the front direction is a range defined by a narrow angle centered around the normal (Z axis) passing through the center of the first flat surface 110 in a plane (in this example, an XZ plane) that is parallel to a plane (in this example, an XZ plane) including a direction (in this example, the X direction) in which the first flat surface 110 and an adjacent inclined surface (in this example, the first inclined surface 120A) are connected together and also including the front direction (Z direction) and that includes the normal (Z axis) passing through the center of the first flat surface 110. As an example, the narrow angular range is an angular range within ±10 degrees centered around the normal (Z direction), is more preferably an angular range within ±5 degrees centered around the normal (Z direction), and is further more preferably an angular range within ±3 degrees centered around the normal (Z direction).

### Base 101

The base 101 is a member having the first flat surface 110 and first inclined surface 120A, which are formed on the +Z-direction side. In FIGS. 1A and 1B, the base 101 is a bent plate-like member common to the first flat surface 110 and first inclined surface 120A, as an example. However, the base 101 is not limited to a bent plate-like member. For example, the base 101 may be a cabinet or the like in a box shape or the like. The base 101 only needs to be a member for which the first flat surface 110 and first inclined surface 120A can be formed. Alternatively, the base 101 may be such that portions at which the first flat surface 110 and first inclined surface 120A are formed are separately structured.

The base 101 can be manufactured from a resin material, a metal material, a glass material, or the like, as an example. The first flat surface 110 and first inclined surface 120A, which form a surface of the base 101, need to be a surface of a conductor. If the base 101 is manufactured from a resin or glass material, therefore, it suffices for the first flat surface 110 and first inclined surface 120A to be structured as surfaces to which conductor plating has been applied. As a resin material, an acrylic resin material, a vinyl chloride resin material, a polyester-based resin material, or the like, for example, can be used. As a metal material, an aluminum material or the like, for example, can be used.

### First Flat Surface 110

The first flat surface 110 is a reflecting surface perpendicular to the front direction of the radio wave reflector 100. This is because the front direction of the radio wave reflector 100 is defined by the extending direction of the normal of the first flat surface 110. The first flat surface 110 is a flat surface. The first flat surface 110 is in a rectangular shape in front view, as an example. Of the reflecting surfaces of the radio wave reflector 100, only the first flat surface 110 is perpendicular to the front direction. The length of the first flat surface 110 in the X direction is denoted a₁ and its length in the Y direction is denoted b₁.

Here, an angle θ (in degrees) with respect to the normal (Z axis) passing through the center of the first flat surface 110 will be defined as illustrated in FIG. 1B. The angle θ is used to represent the reflection direction of a reflected wave in an XZ plane. The angle θ is such that the angle of an inclination from the +Z direction toward the +X-direction side in XZ plane view as illustrated in FIG. 1B is represented as a positive angle and that an angle of an inclination from the +Z direction toward the side opposite to the angle θ illustrated in FIG. 1B, that is, toward the −X-direction side, in XZ plane view, is represented as a negative angle.

The first flat surface 110 is not limited to a rectangular shape. The first flat surface 110 may have any of a polygonal shape, a circular shape, an elliptical shape, and the like. The outer edges of the first flat surface 110 may have a shape equivalent to at least part of a polygonal shape, a circular shape, or an elliptical shape.

### First Inclined Surface 120A

The first inclined surface 120A is a reflecting surface connected to a side that is one of the four sides of the first flat surface 110 and extends in the Y direction on the +X-direction side, the reflecting surface being structured as a flat surface inclined with respect to the first flat surface 110. The length of the first inclined surface 120A in the horizontal direction when the first inclined surface 120A is viewed from the extending direction of the normal n1 is denoted a₂ (the length will be referred to below as the horizontal length of the first inclined surface 120A), and the length of the first inclined surface 120A in the Y direction is denoted b₂. Although the area of the first inclined surface 120A may differ from the area of the first flat surface 110, the difference between these areas is preferably small. As an example, the horizontal length a₂ of the first inclined surface 120A is equal to the length a₁ of the first flat surface 110 in the X direction, and the length b₂ of the first inclined surface 120A in the Y direction is equal to the length b₁ of the first flat surface 110 in the Y direction. Therefore, the area of the first inclined surface 120A is equal to the area of the first flat surface 110, as an example.

The first inclined surface 120A is inclined with respect to the first flat surface 110 so that a valley fold is formed on the boundary between the first inclined surface 120A and the first flat surface 110, as illustrated in FIG. 1B. In other words, in XZ plane view, the first inclined surface 120A is positioned on the +X-direction side of the first flat surface 110 and is inclined so as to approach the Z axis on the positive side.

The first inclined surface 120A is in a rectangular shape as an example. Its side extending in the Y direction on the −X-direction side is connected to the first flat surface 110. The first inclined surface 120A is not limited to a rectangular shape. The first inclined surface 120A may have any of a polygonal shape, a circular shape, an elliptical shape, and the like. The first inclined surface 120A only needs to be inclined with respect to the first flat surface 110 in a state in which the first inclined surface 120A is connected to at least part of the outer edges of the first flat surface 110.

The first inclined surface 120A of this type has the following relationship with the first flat surface 110. The area of the first flat surface 110 and the area of the first inclined surface 120A have a relationship in which the difference between the maximum value of the strengths of reflected waves from the first flat surface 110 and the maximum value of the strengths of reflected waves from the first inclined surface 120A is equal to or smaller than a predetermined value. The first inclined surface 120A is inclined with respect to the first flat surface 110 so that, in an angular distribution of reflected waves with respect to the normal passing through the center of the first flat surface 110, an overlap is formed between an angular range in which the reflected wave from the first flat surface 110 has a predetermined strength or higher and an angular range in which the reflected wave from the first inclined surface 120A has the predetermined strength or higher.

### Evaluation Criterion For The Strength Of The Reflected Wave

As an example of a criterion for the strength of the reflected wave, Radar Cross Section (RCS) is used. The unit of RCS is dBSm. In this embodiment, an angular distribution of reflected waves from the radio wave reflector 100 will be evaluated by using an angular distribution of reflected waves with respect to the normal passing through the center of the first flat surface 110.

When the direction of the normal matches the front direction of the radio wave reflector 100 as with the first flat surface 110, in an antilogarithm representation, RCS of the reflected wave from the first flat surface 110 in the front direction of the radio wave reflector 100 in a rectangular shape can be represented according to Equation (1) below, by using the length a₁ of the first flat surface 110 in the X direction and its length b₁ in the Y direction. In Equation (1), λ is the length of a radio wave in a free space.

$$R C S = \frac{4 {π}_{1}^{2} {b}_{1}^{2}}{{λ}^{2}} \qquad ( 1 )$$

When the direction of the normal n1 forms an angle ϕ (ϕ≠0) with respect to the front direction of the radio wave reflector 100 as with the first inclined surface 120A in a rectangular shape, RCS of the reflected wave from the first inclined surface 120A in the front direction of the radio wave reflector 100 can be represented according to Equation (2) below, by using the horizontal length a₂ of the first inclined surface 120A and its length b₂ in the Y direction. In Equation (2), λ is the length of a radio wave in a free space. The Z′ axis is parallel to the Z axis. According to Equation (2), RCS for the first inclined surface 120A in the front direction of the radio wave reflector 100 is obtained.

$$R C S = \frac{4 π {a}_{2}^{2} {b}_{2}^{2}}{{λ}^{2}} [ \frac{sin ( 2 π {a}_{2} sin ϕ / λ )}{2 π {a}_{2} sin ϕ / λ} ] {cos}^{2} ϕ \qquad ( 2 )$$

Since the radio wave reflector 100 reflects the radio wave in a narrow angular range in the front direction, the angle ϕ of the first inclined surface 120A with respect to the front direction of the radio wave reflector 100 is very small. The absolute value of the angle ϕ is about 0.5 degrees to about 5 degrees, as an example.

### Angular Distribution Of Reflected Waves With Respect To The Normal Passing Through The Center Of The First Flat Surface 110

FIG. 1C illustrates an example of an angular distribution of reflected waves from the radio wave reflector 100. The angular distribution, illustrated in FIG. 1C, of reflected waves from the radio wave reflector 100 is an angular distribution of reflected waves with respect to the normal (Z axis) passing through the center of the first flat surface 110. The angular distribution represents results calculated in an electromagnetic field simulation. In the simulation, an angle formed between the Z axis and the normal n1 of the first inclined surface 120A was set to 3 degrees, as an example. RCS was calculated for both the first flat surface 110 and the first inclined surface 120A according to Equation (1), under the condition that the area of the first flat surface 110 and the area of the first inclined surface 120A are equal to each other, as an example.

In FIG. 1C, the horizontal axis indicates the angle θ (in degrees) and the vertical axis indicates RCS (in dBsm). On the horizontal axis, the angle θ of an inclination from the +Z direction toward the +X-direction side in XZ plane view as illustrated in FIG. 1B is a positive angle; and the angle θ of an inclination from the +Z direction toward the −X-direction side in XZ plane view is a negative angle.

The example of the angular distribution of reflected waves in FIG. 1C is the one when radio waves were incident on the radio wave reflector 100 from the −Z direction. The dotted lines indicate an angular distribution of the strengths of radio waves reflected at the first flat surface 110. The dash-dot lines indicate an angular distribution of the strengths of radio waves reflected at the first inclined surface 120A. The solid lines indicate the total of the angular distribution of the dotted lines and the angular distribution of dash-dot lines. That is, the solid lines indicate an angular distribution of the total strengths of radio waves reflected at the first flat surface 110 and radio waves reflected at the first inclined surface 120A.

In the angular distribution (dotted lines) of the strengths of radio waves reflected at the first flat surface 110, the maximum value of RCS was obtained when the angle θ was 0 degrees, as illustrated in FIG. 1C. It can be considered that since the first flat surface 110 reflects radio waves in the +Z direction, the maximum value of RCS was obtained when the angle θ was 0 degrees. The maximum value of RCS was about 7.48 dBsm. The strength of the reflected wave was lowered as the absolute value of the angle θ became large. When the angle θ was about +2.3 degrees and when it was about −2.3 degrees, RCS was about 0 dBsm. In an angular range in which the angle θ was about +2.3 degrees or more and an angular range in which the angle θ was about −2.3 degrees or less, RCS was about 0 dBsm or less.

In the angular distribution (dash-dot lines s) of the strengths of radio waves reflected at the first inclined surface 120A, the maximum value of RCS was obtained when the angle θ was about −3 degrees. It can be considered that since the first inclined surface 120A is positioned on the +X-direction side of the first flat surface 110 and is inclined so as to approach the Z axis on the positive side and more radio waves are thereby reflected toward the −X-direction side than in the +Z direction, the maximum value of RCS was obtained in a range in which the angle θ was negative.

Since the area of the first inclined surface 120A and the area of first flat surface 110 are equal to each other, the maximum value of RCS for the first inclined surface 120A was about 7.4 dBsm.

It could be confirmed that the strength of the reflected wave from the first inclined surface 120A is lowered as the angle θ deviates from about −3 degrees. When the angle θ was about −0.7 degrees and when the angle θ was about −5.3 degrees, RCS was about 0 dBsm. In an angular range in which the angle θ was about −0.7 degrees or more and an angular range in which the angle θ was about −5.3 degrees or less, RCS was about 0 dBsm or less.

In the angular distribution (solid lines) of the total strengths of radio waves reflected at the first flat surface 110 and radio waves reflected at the first inclined surface 120A, the maximum value of RCS was obtained in a range in which the angle θ was from 0 degrees to about −3 degrees. As an example, a property was obtained that is of the type that links the maximum value (θ=0 degrees) of RCS of the reflected waves from the first flat surface 110 and the maximum value (θ≈−3 degrees) of RCS of the reflected waves from the first inclined surface 120A together in a flat form. The maximum value of RCS was about 7.4 dBsm.

In the angular distribution (solid lines) of the total strengths of radio waves reflected at the first flat surface 110 and radio waves reflected at first inclined surface 120A, RCS was about 0 dBsm when the angle θ was around about +2.3 degrees and when it was around about −5.3 degrees. In an angular range in which the angle θ was about +2.3 degrees or more and an angular range in which the angle θ was about −5.3 degrees or less, RCS was about 0 dBsm or less.

Thus, in the angular distribution (solid lines) of the total strengths of radio waves reflected at the first flat surface 110 and radio waves reflected at the first inclined surface 120A, superior RCS values of about 3 dBsm or more were obtained in a range in which the angle θ was from about −5 degrees to +2.3 degrees. In other ranges (angular ranges in which the angle θ was about −5 degrees or less and it was about +2.3 degrees or more), RCS was rapidly lowered, so it could be confirmed that radio waves can be reflected within a narrow angular range in the front direction.

Since the angle ϕ formed between the Z axis and the normal n1 of the first inclined surface 120A was very small, when the area of the first flat surface 110 and the area of the first inclined surface 120A were made equal to each other, the angular distribution of the total strengths of reflected waves in a narrow angular range including the front direction was made substantially flat and substantially even. Accordingly, it could be confirmed that the difference between the area of the first flat surface 110 and the area of the first inclined surface 120A is preferably small.

FIG. 1D is an enlarged view of the range in FIG. 1C in which the angle θ is within +10 degrees and the range in FIG. 1C in which RCS is −10 dBsm or more. In FIG. 1D, the horizontal axis indicates the angle θ. In the simulation, the first inclined surface 120A was inclined with respect to the first flat surface 110 so that an overlap is formed between an angular range from θ2 to θ3, in which the strength of the reflected wave from the first flat surface 110 becomes a half of the maximum value, and an angular range from θ1 to θ2, in which the strength of the reflected wave from the first inclined surface 120A becomes a half of the maximum value.

The angular range in which the strength of the reflected wave from the first flat surface 110 becomes a half of the maximum value (about 7.4 dBsm) is the angular range from θ2 to θ3, in which the strength of the reflected wave from the first flat surface 110 becomes a value (about 4.4 dBsm) that is 3 dB less than the maximum value. The angular range in which the strength of the reflected wave from the first inclined surface 120A becomes a half of the maximum value (about 7.4 dBsm) is the angular range from θ1 to θ2, in which the strength of the reflected wave from the first inclined surface 120A becomes a value (about 4.4 dBsm) that is 3 dB less than the maximum value.

At angle θ2, there is an overlap between the angular range from θ2 to θ3, in which the strength of the reflected wave from the first flat surface 110 becomes a half of the maximum value, and the angular range from θ1 to θ2, in which the strength of the reflected wave from the first inclined surface 120A becomes a half of the maximum value. That is, when the angle θ of the first inclined surface 120A becomes larger than this, there is no overlap between the angular range in which the strength of the reflected wave from the first flat surface 110 becomes a half of the maximum value and the angular range in which the strength of the reflected wave from the first inclined surface 120A becomes a half of the maximum value.

Since there is an overlap between the angular range from θ1 to θ2 and the angular range from θ2 to θ3, the angular distribution (solid lines) of the total strengths of reflected waves is substantially flat in a narrow angular range including the front direction (θ=0 degrees) between angle θₜ₂, at which the strengths of reflected waves from the first flat surface 110 becomes the maximum value, and angle θₜ₁, at which the strengths of reflected waves from the first inclined surface 120A becomes the maximum value.

Accordingly, it could be confirmed that when the angle ϕ of the first inclined surface 120A is set so that an overlap is formed between angular ranges in each of which the strength of the reflected wave is a half of the maximum value, the angular range in which the maximum value of the strengths of reflected waves is obtained can be widened. It could be also confirmed that when the area of the first flat surface 110 and the area of first inclined surface 120A are equal to each other, the maximum values of the strengths of their respective reflected waves can be made equal to each other.

When the angle ϕ is larger than the angle ϕ of the first inclined surface 120A at a time when the results in FIGS. 1C and 1D were obtained, no overlap is formed between the angular range in which the strengths of reflected wave from the first flat surface 110 are a half of the maximum value and the angular ranges in which the strengths of reflected wave from the first inclined surface 120A are a half of the maximum value, so a valley lower than the maximum value is formed in the vicinity of the front direction in the angular distribution of the total strengths of reflected waves.

However, if a practical problem does not occur, a valley lower than the maximum values may be formed in the vicinity of the front direction in the angular distribution of the total strengths of reflected waves. Thus, the first inclined surface 120A only needs to be inclined with respect to the first flat surface 110 so that, in the angular distribution of reflected waves with respect to the normal passing through the center of the first flat surface 110, an overlap is formed between the angular range in which the reflected wave from the first flat surface 110 has the predetermined strength or higher and the angular range in which the reflected wave from the first inclined surface 120A has the predetermined strength or higher. It is only necessary for the predetermined strength to be equal to or higher than the strength of the reflected wave at the valley described above.

Since the area of the first flat surface 110 and the area of the first inclined surface 120A were equal to each other, the maximum values of the strengths of their respective reflected waves were equal to each other. It could be confirmed that to increase the strength in the vicinity of the front direction in the angular distribution of the total strengths of reflected waves to a certain extent, the difference between the area of the first flat surface 110 and the area of the first inclined surface 120A is preferably small. In other words, it could be confirmed that the area of the first flat surface 110 and the area of the first inclined surface 120A preferably have a relationship in which the difference between the maximum value of the strengths of reflected waves from the first flat surface 110 and the maximum value of the strengths of reflected waves from the first inclined surface 120A is equal to or smaller than the predetermined value.

### First Variation Of The Embodiment

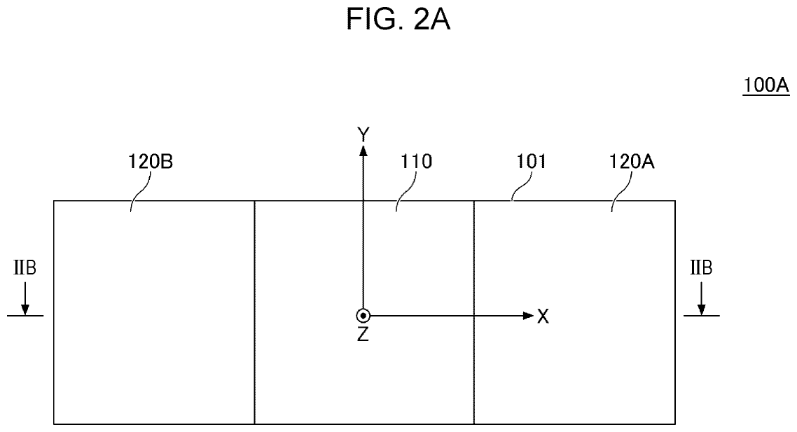

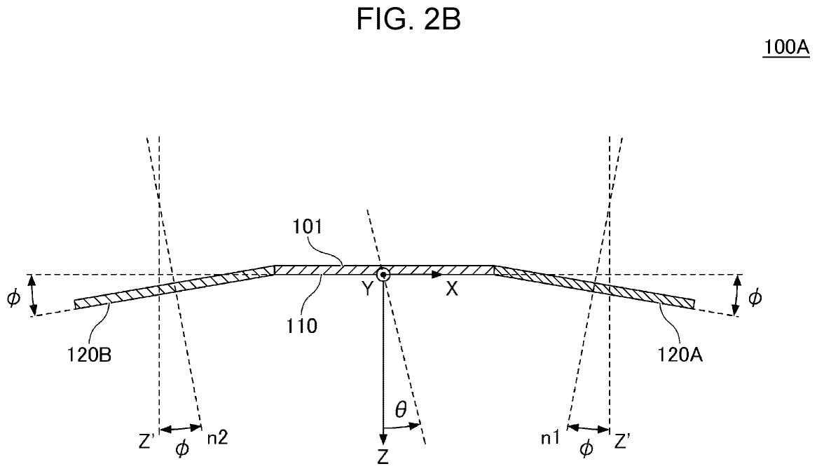

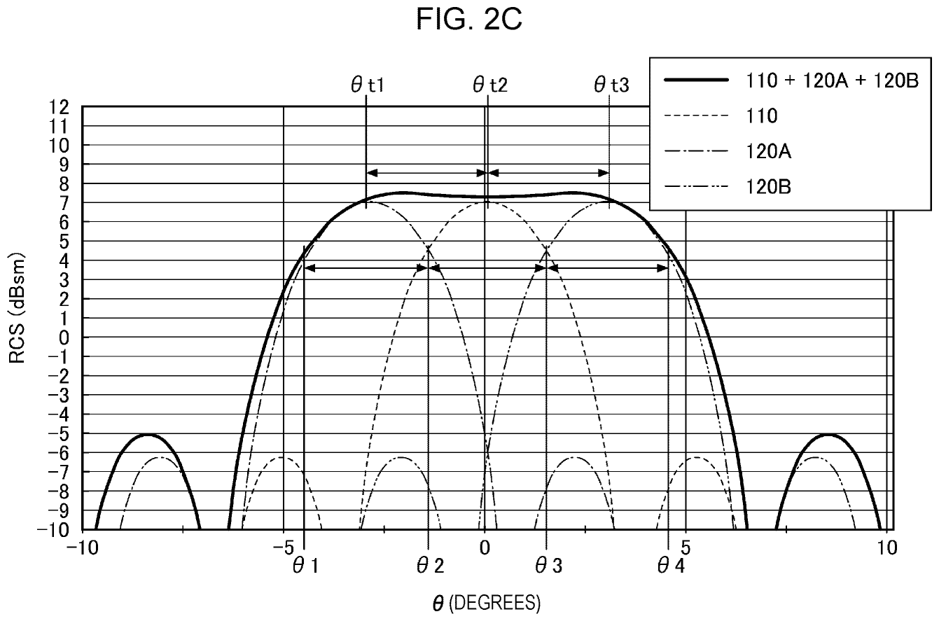

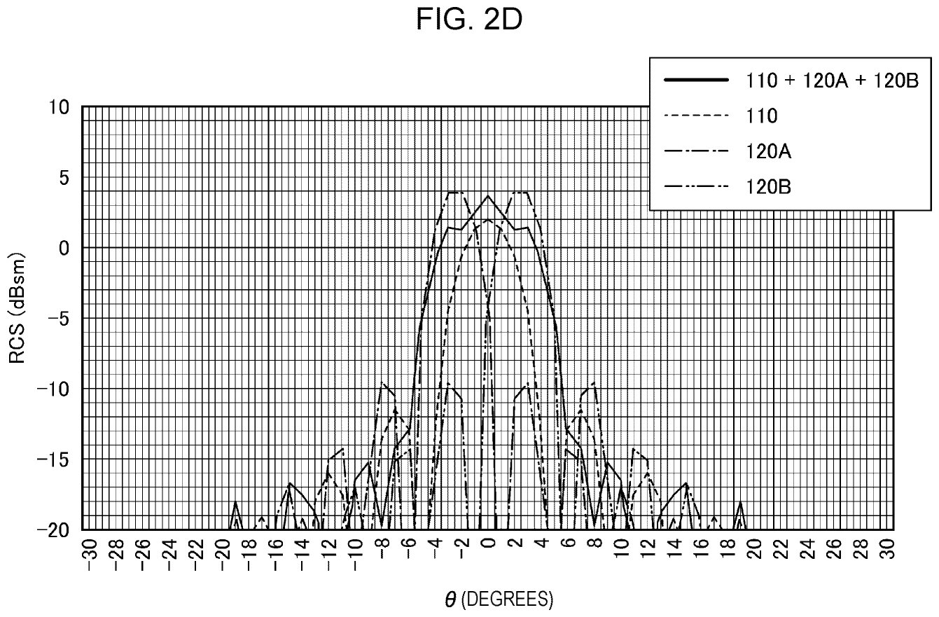

FIGS. 2A and 2B illustrate an example of the structure of a radio wave reflector 100A in a first variation of the embodiment. FIG. 2A is a front view, and FIG. 2B illustrates an example of the structure at the cross section along line IIB-IIB in FIG. 2A.

The radio wave reflector 100A includes the base 101, the first flat surface 110, the first inclined surface 120A, and a second inclined surface 120B. That is, the radio wave reflector 100A in the first variation of the embodiment has a structure in which the second inclined surface 120B is added to the radio wave reflector 100 (see FIGS. 1A and 1B) in the embodiment. The radio wave reflector 100A reflects the radio waves at the first flat surface 110, first inclined surface 120A, and second inclined surface 120B so that these radio waves can be reflected in a narrow angular range in the front direction. The radio wave reflector 100A will be described below, focusing on the difference from the radio wave reflector 100.

### Base 101

The base 101 in the first variation of the embodiment is a member having the first flat surface 110, first inclined surface 120A, and second inclined 120B, which are formed on the +Z-direction side. In FIGS. 2A and 2B, the base 101 is a bent plate-like member common to the first flat surface 110, first inclined surface 120A, and second inclined surface 120B, as an example. However, the base 101 is not limited to a bent plate-like member. For example, the base 101 may be a cabinet or the like in a box shape or the like. The base 101 only needs to be a member for which the first flat surface 110 and first inclined surface 120A can be formed. Alternatively, the base 101 may be such that portions at which the first flat surface 110 and first inclined surface 120A are formed are separately structured. The material of the base 101 is similar to the material of the base 101 illustrated in FIG. 1A and 1B.

### Second Inclined Surface 120B

The second inclined surface 120B is positioned on a side opposite to the first inclined surface 120A with the first flat surface 110 interposed between the first inclined surface 120A and the second inclined surface 120B. The second inclined surface 120B is a reflecting surface connected to a side that is one of the four sides of the first flat surface 110 and extends in the Y direction on the −X-direction side, the reflecting surface being structured as a flat surface inclined with respect to the first flat surface 110. Although the area of the second inclined surface 120B may differ from the area of the first flat surface 110, the difference between these areas is preferably small. Similarly, although the area of the second inclined surface 120B may differ from the area of the first inclined surface 120A, the difference between these areas is preferably small.

As an example, a horizontal length when the second inclined surface 120B is viewed from the extending direction of a normal n2 (the length will be referred to below as the horizontal length about the second inclined surface 120B) is equal to the length of the first flat surface 110 in the X direction, and is also equal to the horizontal length of the first inclined surface 120A. The length of the second inclined surface 120B in the Y direction is equal to the length of the first flat surface 110 in the Y direction and is also equal to the length of the first inclined surface 120A in the Y direction. Therefore, the area of the second inclined surface 120B is equal to the area of the first flat surface 110 and to the area of the first inclined surface 120A, as an example.

The second inclined surface 120B is inclined with respect to the first flat surface 110 so that a valley fold is formed on the boundary between the second inclined surface 120B and the first flat surface 110, as illustrated in FIG. 2B. In other words, in XZ plane view, the second inclined surface 120B is positioned on the −X-direction side of the first flat surface 110 and is inclined so as to approach the Z axis on the positive side. The angle of the second inclined surface 120B with respect to the first flat surface 110 may differ from the angle of the first inclined surface 120A with respect to the first flat surface 110. To increase symmetry, however, their inclination angles are preferably equal to each other. In FIG. 2B, the angles (inclination angles) of the second inclined surface 120B and first inclined surface 120A with respect to the first flat surface 110 are both an absolute value of ϕ.

The second inclined surface 120B is in a rectangular shape as an example. Its side extending in the Y direction on the +X-direction side is connected to the first flat surface 110. The second inclined surface 120B is not limited to a rectangular shape. The second inclined surface 120B may have any of a polygonal shape, a circular shape, an elliptical shape, and the like. The second inclined surface 120B only needs to be inclined with respect to the first flat surface 110 in a state in which the second inclined surface 120B is connected to at least part of the outer edges of the first flat surface 110. To increase symmetry, it is most preferable for the shape of the second inclined surface 120B to be equal to the shape of the first inclined surface 120A. In this case, it is most preferable for the area of the second inclined surface 120B and the area of the first inclined surface 120A to be equal to each other and it is also most preferable for their angles with respect to the first flat surface 110 to be equal to each other.

The second inclined surface 120B of this type has the following relationship with the first flat surface 110. The area of the first flat surface 110 and the area of the second inclined surface 120B have a relationship in which the difference between the maximum value of the strengths of reflected waves from the first flat surface 110 and the maximum value of the strengths of reflected waves from the second inclined surface 120B is equal to or smaller than a predetermined value. The second inclined surface 120B is inclined with respect to the first flat surface 110 so that, in an angular distribution of reflected waves with respect to the normal passing through the center of the first flat surface 110, an overlap is formed between the angular range in which the reflected wave from the first flat surface 110 has the predetermined strength or higher and the angular range in which the reflected wave from the second inclined surface 120B has the predetermined strength or higher. This is similar to the relationship between the first flat surface 110 and the first inclined surface 120A.

### Angular Distribution Of Reflected Waves With Respect To The Normal Passing Through The Center Of The First Flat Surface 110

FIG. 2C illustrates an example of an angular distribution of reflected waves from the radio wave reflector 100A. The angular distribution, illustrated in FIG. 2C, of reflected waves from the radio wave reflector 100A is an angular distribution of reflected waves with respect to the normal (Z axis) passing through the center of the first flat surface 110. The angular distribution represents results calculated in an electromagnetic field simulation. In the simulation, an angle formed between the Z axis and the normal n1 of the first inclined surface 120A was set to an absolute value of 3 degrees and an angle formed between the Z axis and the normal n2 of the second inclined surface 120B was set to an absolute value of 3 degrees, as an example. For all of the first flat surface 110, first inclined surface 120A, and second inclined surface 120B, RCS was calculated according to equation (1) under the condition that the area of the first flat surface 110, the area of the first inclined surface 120A, and the area of the second inclined surface 120B are equal to one another, as an example.

In FIG. 2C, the horizontal axis indicates the angle θ (in degrees) and the vertical axis indicates RCS (in dBsm). On the horizontal axis, the angle θ of an inclination from the +Z direction toward the +X-direction side in XZ plane view as illustrated in FIG. 2B is a positive angle; and the angle θ of an inclination from the +Z direction toward the −X-direction side in XZ plane view is a negative angle.

The example of the angular distribution of reflected waves in FIG. 2C is the one when radio waves were incident on the radio wave reflector 100A from the −Z direction. The dotted lines indicate an angular distribution of the strengths of radio waves reflected at the first flat surface 110. The dash-dot lines indicate an angular distribution of the strengths of radio waves reflected at the first inclined surface 120A. The dash-dot-dot lines indicate an angular distribution of the strengths of radio waves reflected at the second inclined surface 120B. The solid lines indicate the total of the angular distribution of the dotted lines, the angular distribution of dash-dot lines, and the angular distribution of dash-dot-dot lines. That is, the solid lines indicate an angular distribution of the total strengths of radio waves reflected at the first flat surface 110, radio waves reflected at the first inclined surface 120A, and radio waves reflected at the second inclined surface 120B.

In FIG. 2C, the angular distribution (dotted lines) of the strengths of radio waves reflected at the first flat surface 110 and the angular distribution (dash-dot lines) of the strengths of radio waves reflected at the first inclined surface 120A are identical to the results illustrated in FIG. 1C.

The angular distribution (dash-dot-dot lines) of the strengths of radio waves reflected at the second inclined surface 120B is symmetric to the angular distribution (dash-dot lines) of the strengths of radio waves reflected at the first inclined surface 120A, in a direction (horizontal direction in FIG. 2C) in which the angle θ is increased with respect to 0 degrees (θ=0 degrees) equivalent to the front direction. When the angle θ was about 3.5 degrees, the maximum value was obtained. It can be considered that since the second inclined surface 120B is positioned on the −X-direction side of the first flat surface 110 and is inclined so as to approach the Z axis on the positive side and more radio waves are thereby reflected toward the +X-direction side than in the +Z direction, the maximum value of RCS was obtained in a range in which the angle θ was positive.

Since the area of the second inclined surface 120B, the area of the first flat surface 110, and the area of the first inclined surface 120A are equal to one another, the maximum value of RCS for the second inclined surface 120B was substantially equal to the maximum value for the first flat surface 110 and the maximum value for the first inclined surface 120A, that is, the maximum value of RCS for the second inclined surface 120B was about 7.4 dBsm.

In the angular distribution (solid lines) of the total strengths of radio waves reflected at the first flat surface 110, radio waves reflected at the first inclined surface 120A, and radio waves reflected at the second inclined surface 120B, the maximum value of RCS was obtained in a range in which the angle θ was from about −3 degrees to about +3 degrees. As an example, a property was obtained that is of the type that links the maximum value (θ≈−3 degrees) of RCS of the reflected waves from the first inclined surface 120A and the maximum value (θ≈+3 degrees) of RCS of the reflected waves from the second inclined surface 120B together in a flat form. The maximum value of RCS was about 7.4 dBsm.

In the angular distribution (solid lines) of the total strengths of radio waves reflected at the first flat surface 110, radio waves reflected at the first inclined surface 120A, and radio waves reflected at the second inclined surface 120B, RCS was about 0 dBsm when the angle θ was around about—−5.5 degrees and when it was around about +5.5 degrees. In an angular range in which the angle θ was about −5.5 degrees or less and an angular range in which the angle θ was about +5.5 degrees or more, RCS was about 0 dBsm or less.

Thus, in the angular distribution (solid lines) of the total strengths of radio waves reflected at the first flat surface 110, radio waves reflected at the first inclined surface 120A, and radio waves reflected at the second inclined surface 120B, superior RCS values of about 3 dBsm or more were obtained in a range in which the angle θ was from about −4.8 degrees to about +5 degrees. In other ranges (angular ranges in which the angle θ was about −4.8 degrees or less and it was about +5 degrees or more), RCS was rapidly lowered, so it could be confirmed that radio waves can be reflected within a narrow angular range in the front direction.

Since the angle ϕ formed between the Z axis and the normal n1 of the first inclined surface 120A was very small, when the area of the first flat surface 110, the area of the first inclined surface 120A, and the area of the second inclined surface 120B were made equal to one another, the angular distribution of the total strengths of reflected waves in a narrow angular range including the front direction was made substantially flat and substantially even. Accordingly, it could be confirmed that the difference among the area of the first flat surface 110, the area of the first inclined surface 120A, and the area of the second inclined surface 120B is preferably small.

In the simulation, the second inclined surface 120B was inclined with respect to the first flat surface 110 so that an overlap is formed between an angular range from θ2 to θ3 in which the strength of the reflected wave from the first flat surface 110 becomes a half of the maximum value and an angular range from θ3 to angle θ4 in which the strength of the reflected wave from the second inclined surface 120B becomes a half of the maximum value. There is an overlap between an angular range from θ2 to θ3 in which the strength of the reflected wave from the first flat surface 110 becomes a half of the maximum value and an angular range from θ1 to θ2 in which the strength of the reflected wave from the first inclined surface 120A becomes a half of the maximum value, as described with reference to FIG. 1D.

The angular range in which the strength of the reflected wave from the second inclined surface 120B becomes a half of the maximum value (about 7.4 dBsm) is the angular range from θ3 to θ4, in which the strength of the reflected wave from the second inclined surface 120B becomes a value (about 4.4 dBsm) that is 3 dB less than the maximum value.

At angle θ3, there is an overlap between the angular range from θ2 to θ3, in which the strength of the reflected wave from the first flat surface 110 becomes a half of the maximum value, and the angular range from θ3 to θ4, in which the strength of the reflected wave from the second inclined surface 120B becomes a half of the maximum value. That is, when the absolute value of the angle ϕ of the second inclined surface 120B becomes larger than this, there is no overlap between the angular range in which the strength of the reflected wave from the second inclined surface 120B becomes a half of the maximum value and the angular range in which the strength of the reflected wave from the first inclined surface 120A becomes a half of the maximum value.

Since there are an overlap between the angular range from θ1 to θ2 and the angular range from θ2 to θ3 and an overlap between the angular range from θ2 to θ3 and the angular range from θ3 to θ4, the angular distribution (solid lines) of the total strengths of reflected waves is substantially flat in a narrow angular range including the front direction (θ=0 degrees) between angle θₜ₁, at which the strengths of reflected waves from the first inclined surface 120A becomes the maximum value and angle θₜ₃, at which the strengths of reflected waves from the second inclined surface 120B becomes the maximum value.

Accordingly, it could be confirmed that when the angle ϕ of the first inclined surface 120A and the angle ϕ of second inclined surface 120B are set so that an overlap is formed between angular ranges in each of which the strength of the reflected wave is a half of the maximum value, the angular range in which the maximum value of the strengths of reflected waves is obtained can be made wider than when the radio wave reflector 100 indicated in FIGS. 1A and 1B is used. It could also be confirmed that when the area of the first flat surface 110, the area of the first inclined surface 120A, and the area of the second inclined surface 120B are equal to one another, the three maximum values of the strengths of their respective reflected waves can be made equal to one another.

When the angle ϕ is larger than the angle ϕ of the second inclined surface 120B at a time when the results in FIG. 2C were obtained, no overlap is formed between the angular range in which the strengths of reflected waves from the first flat surface 110 are a half of the maximum value and the angular ranges in which the strengths of reflected waves from the second inclined surface 120B are a half of the maximum value, so a valley lower than the maximum value is formed in the vicinity of the front direction in the angular distribution of the total strengths of reflected waves.

However, if a practical problem does not occur, a valley lower than the maximum value may be formed in the vicinity of the front direction in the angular distribution of the total strengths of reflected waves. Thus, the second inclined surface 120B only needs to be inclined with respect to the first flat surface 110 so that, in the angular distribution of reflected waves with respect to the normal passing through the center of the first flat surface 110, an overlap is formed between the angular range in which the reflected wave from the first flat surface 110 has the predetermined strength or higher and the angular range in which the reflected wave from the second inclined surface 120B has the predetermined strength or higher. It is only necessary for the predetermined strength to be equal to or higher than the strength of the reflected wave at the valley described above. Similarly, this also holds for the relationship between the first flat surface 110 and the first inclined surface 120A described with reference to FIGS. 1A to 1D.

Since the area of the first flat surface 110, the areas of the first inclined surface 120A, and the area of the second inclined surface 120B are equal to one another, the maximum values of the strengths of their respective reflected waves are equal to one another. It could be confirmed that to increase the strength in the vicinity of the front direction in the angular distribution of the total strengths of reflected waves to a certain extent, the difference among the area of the first flat surface 110, the area of the first inclined surface 120A, and the area of the second inclined surface 120B is preferably small. In other words, it could be confirmed that the area of the first flat surface 110, the area of the first inclined surface 120A, and the area of the second inclined surface 120B preferably have a relationship in which the difference among the maximum value of the strengths of reflected waves from the first flat surface 110, the maximum value of the strengths of reflected waves from the first inclined surface 120A, and the maximum value of the strengths of reflected waves from the second inclined surface 120B is equal to or smaller than the predetermined value.

For example, when the maximum values of the strengths of reflected waves from the first inclined surface 120A and second inclined surface 120B are larger than the maximum value of the strengths of reflected waves from the first flat surface 110 and the maximum values of the strengths of reflected waves from the first inclined surface 120A and second inclined surface 120B are equal to each other, a property as illustrated in FIG. 2D is obtained.

FIG. 2D illustrates another example of an angular distribution of reflected waves from the radio wave reflector 100A in the first variation of the embodiment. The property in FIG. 2D was calculated in an electromagnetic field simulation, as in FIG. 2C.

In FIG. 2D, the dotted lines indicate an angular distribution of the strengths of radio waves reflected at the first flat surface 110, the dash-dot lines indicate an angular distribution of the strengths of radio waves reflected at the first inclined surface 120A, the dash-dot-dot lines indicate an angular distribution of the strengths of radio waves reflected at the second inclined surface 120B, and the solid lines indicate an angular distribution of the total strengths of radio waves reflected at the first flat surface 110, radio waves reflected at the first inclined surface 120A, and radio waves reflected at the second inclined surface 120B.

Since the maximum values of the strengths of reflected waves from the first inclined surface 120A and second inclined surface 120B are larger than the maximum value of the strengths of reflected waves from the first flat surface 110, the area of the first inclined surface 120A and the area of the second inclined surface 120B are larger than the area of the first flat surface 110. Since the maximum values of the strengths of reflected waves from the first inclined surface 120A and second inclined surface 120B are equal to each other, the area of the first inclined surface 120A and the area of the second inclined surface 120B are equal to each other.

In this type of case, a distribution in which the strength in the front direction is maximized is obtained as indicated by the solid lines in FIG. 2D, as an example.

### Second Variation Of The Embodiment

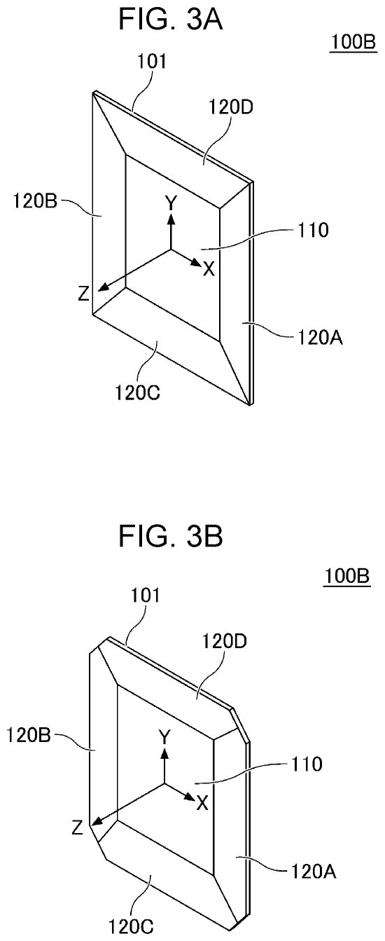

FIG. 3A illustrates an example of the structure of a radio wave reflector 100B in a second variation of the embodiment.

The radio wave reflector 100B has a structure in which the first inclined surface 120A, the second inclined surface 120B, a third inclined surface 120C, and a fourth inclined surface 120D are provided in a trapezoidal shape along the outer edges (four sides) of the first flat surface 110, the outer edges being in a rectangular shape. To match the structure of this type, the base 101 has a different shape from the base 101 illustrated in FIGS. 1A, 1B, 2A, and 2B.

Specifically, the radio wave reflector 100B has a structure in which the first inclined surface 120A and second inclined surface 120B indicated in FIGS. 2A and 2B are changed to a trapezoidal shape, the third inclined surface 120C in a trapezoidal shape is connected to an edge of the first flat surface 110 in the −Y direction, and the fourth inclined surface 120D in a trapezoidal shape is connected to an edge of the first flat surface 110 in the +Y direction. A side of the first inclined surface 120A, the side corresponding to the upper base of the trapezoidal shape, is connected to a respective one of the four sides of the first flat surface 110. This also holds for the second inclined surface 120B, third inclined surface 120C, and fourth inclined surface 120D.

Therefore, the cross section of the radio wave reflector 100B, as taken along an XZ plane passing through the center of the first flat surface 110, is similar to the cross section in FIG. 2B, and the cross section of the radio wave reflector 100B, as taken along an XY plane passing through the center of the first flat surface 110 includes the third inclined surface 120C and fourth inclined surface 120D instead of the first inclined surface 120A and second inclined surface 120B in FIG. 2B.

As the angular distribution of radio waves reflected at the radio wave reflector 100B, a distribution is obtained in which the strength of the reflected wave becomes high on both sides with respect to 0 degrees, as illustrated in FIG. 2C or 2D, on both the XY cross section and XZ cross section passing through the center of the first flat surface 110.

The first inclined surface 120A, third inclined surface 120C, second inclined surface 120B, and fourth inclined surface 120D are in a trapezoidal shape and are placed in that order when viewed from the front direction, enclosing the four outer sides of the rectangular shape of the first flat surface 110, as an example. Along the four sides of the first flat surface 110, the first inclined surface 120A, third inclined surface 120C, second inclined surface 120B, and fourth inclined surface 120D are formed in a mortar shape or tapered shape without a clearance.

Therefore, reflected waves from the first inclined surface 120A and second inclined surface 120B are symmetrically and more evenly combined together, and reflected waves from the third inclined surface 120C and fourth inclined surface 120D are symmetrically and more evenly combined together. Thus, it is possible to provide the radio wave reflector 100B that, in a desired angular range (narrow angular range) in the front direction, achieves high symmetry in angular distributions on both an XY cross section and an XZ cross section and also achieves even radio wave strengths.

The inclination angles of the first inclined surface 120A and second inclined surface 120B with respect to the first flat surface 110 may be equal to each other, and the inclination angles of the third inclined surface 120C and fourth inclined surface 120D with respect to the first flat surface 110 may be equal to each other, as an example. Also, the inclination angles of the first inclined surface 120A and third inclined surface 120C with respect to the first flat surface 110 may be equal to each other, as an example. In this case, a distribution is obtained in which the strength of the reflected wave becomes high on both sides with respect to 0 degrees on both the XY cross section and XZ cross section passing through the center of the first flat surface 110, so angular distributions on both the XY cross section and XZ cross section passing through the center of the first flat surface 110 can be made even.

Alternatively, the inclination angles of the first inclined surface 120A and second inclined surface 120B with respect to the first flat surface 110 may be equal to each other, the inclination angles of the third inclined surface 120C and fourth inclined surface 120D with respect to the first flat surface 110 may be equal to each other, and the inclination angles of the first inclined surface 120A and third inclined surface 120C with respect to the first flat surface 110 may be different from each other, as an example. In this case, a distribution is obtained in which the strength of the reflected wave becomes high on both sides with respect to 0 degrees on both the XY cross section and XZ cross section passing through the center of the first flat surface 110, so different angular distributions are possible between the XY cross section and XZ cross section passing through the center of the first flat surface 110.

If the reflection direction is intentionally shifted with respect to the front direction, the inclination angles of the first inclined surface 120A and second inclined surface 120B with respect to the first flat surface 110 do not need to be equal to each other. Similarly, the inclination angles of the third inclined surface 120C and fourth inclined surface 120D with respect to the first flat surface 110 do not need to be equal to each other. When inclination angles are set for the first inclined surface 120A and second inclined surface 120B with respect to the first flat surface 110, for example, it is possible to obtain a reflected wave strength distribution that includes the front direction and deviates toward the +X-direction side or −X-direction side with respect to the +Z direction in XZ plane view. Similarly, when inclination angles are set for the third inclined surface 120C and fourth inclined surface 120D with respect to the first flat surface 110, for example, it is possible to obtain a reflected wave strength distribution that includes the front direction and deviates toward the −Y-direction side or +Y-direction side with respect to the +Z direction in XY plane view.

The area of the first flat surface 110, the area of the first inclined surface 120A, the area of the second inclined surface 120B, the area of the third inclined surface 120C, and the area of the fourth inclined surface 120D may be equal to one another. The total strength of radio waves from the five reflection surfaces can be made even on both the XY cross section and the XZ cross section in a narrow angular direction including the front direction.

The first inclined surface 120A may be inclined with respect to the first flat surface 110 so that an overlap is formed in an angular distribution of reflected waves with respect to the normal passing through the center of the first flat surface 110 between an angular range in which the strength of the reflected wave from the first flat surface 110 becomes a half of the maximum value and an angular range in which the strength of the reflected wave from the first inclined surface 120A becomes a half of the maximum value.

In this case, the second inclined surface 120B may be inclined with respect to the first flat surface 110 so that an overlap is formed in an angular distribution of reflected waves with respect to the normal passing through the center of the first flat surface 110 between an angular range in which the strength of the reflected wave from the first flat surface 110 becomes a half of the maximum value and an angular range in which the strength of the reflected wave from the second inclined surface 120B becomes a half of the maximum value.

In this case, the third inclined surface 120C may be inclined with respect to the first flat surface 110 so that an overlap is formed in an angular distribution of reflected waves with respect to the normal passing through the center of the first flat surface 110 between an angular range in which the strength of the reflected wave from the first flat surface 110 becomes a half of the maximum value and an angular range in which the strength of the reflected wave from the third inclined surface 120C becomes a half of the maximum value.

In this case, the fourth inclined surface 120D may be inclined with respect to the first flat surface 110 so that an overlap is formed in an angular distribution of reflected waves with respect to the normal passing through the center of the first flat surface 110 between an angular range in which the strength of the reflected wave from the first flat surface 110 becomes a half of the maximum value and an angular range in which the strength of the reflected wave from the fourth inclined surface 120D becomes a half of the maximum value.

In these cases, the angular range in which the maximum value of the strengths of reflected waves is obtained can be further expanded.

The four corners formed by the first inclined surface 120A, third inclined surface 120C, second inclined surface 120B, and fourth inclined surface 120D of the radio wave reflector 100B may have been chamfered as illustrated in FIG. 3B. The trapezoidal shapes of the first inclined surface 120A, third inclined surface 120C, second inclined surface 120B, and fourth inclined surface 120D are construed as including a shape of this type.

An aspect in which four inclined surfaces, which are the first inclined surface 120A, third inclined surface 120C, second inclined surface 120B, and fourth inclined surface 120D, are disposed around the first flat surface 110 has been described with reference to FIGS. 3A and 3B. However, the radio wave reflector 100B may include only any three of the first inclined surface 120A, third inclined surface 120C, second inclined surface 120B, and fourth inclined surface 120D around the first flat surface 110.

### Other Variations Of The Embodiment

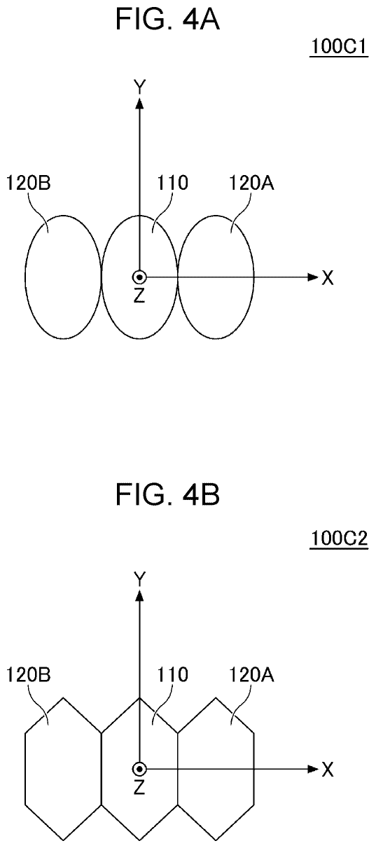

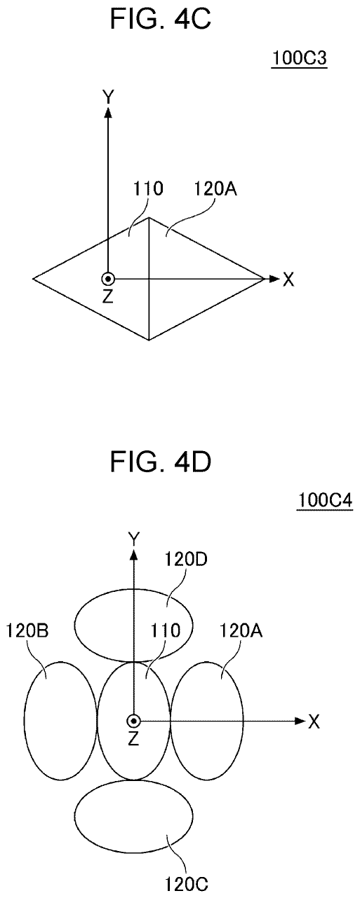

FIGS. 4A to 4D illustrate examples of the structures of radio wave reflectors 100C1 to 100C4 in other variations of the embodiment. In FIGS. 4A to 4D, the base 101 is omitted and the structure of only reflected surfaces is indicated in front view.

The radio wave reflector 100C1 illustrated in FIG. 4A has a structure in which the first flat surface 110, first inclined surface 120A, and second inclined surface 120B of the radio wave reflector 100A illustrated in FIG. 2A are deformed to an elliptical shape. The shape of the first flat surface 110, first inclined surface 120A, and second inclined surface 120B may be a circular shape instead of an elliptical shape. A shape of this type may be taken in conformity with, for example, restrictions and the like on structures and the like around the place at which to attach the base 101.

The radio wave reflector 100C2 illustrated in FIG. 4B has a structure in which the first flat surface 110, first inclined surface 120A, and second inclined surface 120B of the radio wave reflector 100A illustrated in FIG. 2A are deformed to a hexagonal shape (polygonal shape). A polygonal shape only needs to have three sides or more. When the polygonal shape is a quadrangular shape, a rhombic shape or the like may be taken. A shape of this type may be taken in conformity with restrictions and the like on structures and the like around the place at which to attach the base 101. The positions of the first inclined surface 120A and second inclined surface 120B with respect to the first flat surface 110 may be shifted in the Y direction.

The radio wave reflector 100C3 illustrated in FIG. 4C has a structure in which the first flat surface 110 and first inclined surface 120A of the radio wave reflector 100 illustrated in FIG. 1A are deformed to a triangular shape. A shape of this type may be taken in conformity with, for example, restrictions and the like on structures and the like around the place at which to attach the base 101.

The radio wave reflector 100C4 illustrated in FIG. 4D has a structure in which the first flat surface 110, first inclined surface 120A, second inclined surface 120B, third inclined surface 120C, and fourth inclined surface 120D of the radio wave reflector 100B illustrated in FIG. 3A are deformed to an elliptical shape. The shapes of the first flat surface 110, first inclined surface 120A, second inclined surface 120B, third inclined surface 120C, and fourth inclined surface 120D may be a circular shape instead of an elliptical shape. A shape of this type may be taken in conformity with, for example, restrictions and the like on structures and the like around the place at which to attach the base 101.

Structures in which the reflecting surface has an elliptical shape, a circular shape, or a polygonal shape having three sides or more have been described with reference to FIGS. 4A to 4D. However, the outer edges of at least one of a plurality of reflecting surfaces may have a shape equivalent to at least part of a polygonal shape, a circular shape, or an elliptical shape. It is possible to provide the radio wave reflector 100 with a structure having a great deal of freedom, in conformity with various purposes, restrictions on the surroundings, and the like.

The first inclined surface 120A may be an inclined surface that encloses all outer edges of the first flat surface 110. For example, the first flat surface 110 may be in a circular shape or elliptical shape and the first inclined surface 120A may be in a mortar shape or tapered shape that encloses all outer edges of the first flat surface 110 in a circular shape or elliptical shape. A shape of this type may be taken in conformity with, for example, restrictions and the like on structures and the like around the place at which to attach the base 101. It is possible to provide the radio wave reflector 100 with a structure having a great deal of freedom, in conformity with various purposes, restrictions on the surroundings, and the like.

### Effects

The radio wave reflector 100 includes the first flat surface 110 that reflects a radio wave, and also includes the first inclined surface 120A that is connected to at least part of the outer edges of the first flat surface 110, is inclined with respect to the first flat surface 110, and reflects a radio wave. The area of the first flat surface 110 and the area of the first inclined surface 120A have a relationship in which the difference between the maximum value of the strengths of reflected waves from the first flat surface 110 and the maximum value of the strengths of reflected waves from the first inclined surface 120A is equal to or smaller than a predetermined value. In an angular distribution of reflected waves with respect to a normal passing through the center of the first flat surface 110, the first inclined surface 120A is inclined with respect to the first flat surface 110 so that an overlap is formed between an angular range in which the reflected wave from the first flat surface 110 has a predetermined strength or higher and an angular range in which the reflected wave from the first inclined surface 120A has the predetermined strength or higher. Thus, the radio wave reflector 100 having a desired angular range (narrow angular range) in a front direction is obtained.

Therefore, it is possible to provide the radio wave reflector 100 that can reflect radio waves in a narrow angular range in the front direction.

The first flat surface 110 may be in a rectangular shape. Thus, it is possible to provide the radio wave reflector 100 that is easy to manufacture and can reflect radio waves in a narrow angular range in the front direction.

The first inclined surface 120A may be in a rectangular shape. Thus, it is possible to provide the radio wave reflector 100 that is easy to manufacture and can reflect radio waves in a narrow angular range in the front direction.

The radio wave reflector 100 may further include the second inclined surface 120B that is connected to at least part of the outer edges of the first flat surface 110, is inclined with respect to the first flat surface 110, and reflects a radio wave, the second inclined surface 120B being positioned on a side opposite to the first inclined surface 120A with the first flat surface 110 interposed between the first inclined surface 120A and the second inclined surface 120B. The area of the first flat surface 110 and the area of the second inclined surface 120B may have a relationship in which the difference between the maximum value of the strengths of reflected waves from the first flat surface 110 and the maximum value of the strengths of reflected waves from the second inclined surface 120B is equal to or smaller than a predetermined value. In an angular distribution of reflected waves with respect to the normal passing through the center of the first flat surface 110, the second inclined surface 120B may be inclined with respect to the first flat surface 110 so that an overlap is formed between an angular range in which the reflected wave from the first flat surface 110 has the predetermined strength or higher and an angular range in which the reflected wave from the second inclined surface 120B has the predetermined strength or higher. Thus, when reflected waves from the first flat surface 110, first inclined surface 120A, and second inclined surface 120B are combined together, it is possible to provide the radio wave reflector 100 that can reflect radio waves in a desired angular range (narrow angular range) in the front direction.

The inclination angles of the first inclined surface 120A and second inclined surface 120B with respect to the first flat surface 110 may be equal to each other. When reflected waves from the first flat surface 110, first inclined surface 120A, and second inclined surface 120B are combined together, reflected waves from the first inclined surface 120A and second inclined surface 120B are symmetrically and more evenly combined together. Therefore, it is possible to provide the radio wave reflector 100. Thus, it is possible to provide the radio wave reflector 100B that achieves high symmetry and even radio wave strengths in a desired angular range (narrow angular range) in the front direction.

The area of the first flat surface 110 and the area of the first inclined surface 120A may be equal to each other. When reflected waves from the first flat surface 110, first inclined surface 120A, and second inclined surface 120B are combined together, reflected waves from the first inclined surface 120A and second inclined surface 120B are symmetrically and more evenly combined together. Therefore, it is possible to provide the radio wave reflector 100. Thus, it is possible to provide the radio wave reflector 100B that achieves high symmetry and even radio wave strengths in a desired angular range (narrow angular range) in the front direction.

In an angular distribution of reflected waves with respect to the normal passing through the center of the first flat surface 110, the first inclined surface 120A may be inclined with respect to the first flat surface 110 so that an overlap is formed between an angular range in which the strength of the reflected wave from the first flat surface 110 becomes a half of the maximum value and an angular range in which the strength of the reflected wave from the first inclined surface 120A becomes a half of the maximum value. In a narrow angular range including the front direction, the radio wave reflector 100 can make an angular distribution of the total strengths of reflected waves substantially flat and substantially even. Therefore, it is possible to provide the radio wave reflector 100 that features high symmetry and moreover even and flat radio wave strengths in a desired angular range (narrow angular range) in the front direction.

This completes the description of the radio wave reflector in an exemplary embodiment of the present disclosure. However, the present disclosure is not limited to specifically disclosed embodiments, but can be varied and modified in various other ways without departing from the scope of the claims.

What is claimed is:

1. A radio wave reflector comprising:
a first flat surface that reflects a radio wave; and
a first inclined surface that is connected to at least part of an outer edge of the first flat surface, is inclined with respect to the first flat surface, and reflects a radio wave; wherein
an area of the first flat surface and an area of the first inclined surface have a relationship in which a difference between a maximum value of a strength of a reflected wave from the first flat surface and a maximum value of a strength of a reflected wave from the first inclined surface is equal to or smaller than a predetermined value, and
in an angular distribution of the reflected wave with respect to a normal passing through a center of the first flat surface, the first inclined surface is inclined with respect to the first flat surface so that an overlap is formed between an angular range in which the reflected wave from the first flat surface has a predetermined strength or higher and an angular range in which the reflected wave from the first inclined surface has the predetermined strength or higher.

2. The radio wave reflector according to claim 1, wherein the first flat surface is in a rectangular shape.

3. The radio wave reflector according to claim 1, wherein the first inclined surface is in a rectangular shape.

4. The radio wave reflector according to claim 3, further comprising a second inclined surface that is connected to at least part of the outer edge of the first flat surface, is inclined with respect to the first flat surface, and reflects a radio wave, the second inclined surface being positioned on a side opposite to the first inclined surface with the first flat surface interposed between the first inclined surface and the second inclined surface, wherein:
the area of the first flat surface and an area of the second inclined surface have a relationship in which a difference between the maximum value of the strength of the reflected wave from the first flat surface and a maximum value of a strength of a reflected wave from the second inclined surface is equal to or smaller than a predetermined value; and
in the angular distribution of the reflected wave with respect to the normal passing through the center of the first flat surface, the second inclined surface is inclined with respect to the first flat surface so that an overlap is formed between the angular range in which the reflected wave from the first flat surface has the predetermined strength or higher and an angular range in which the reflected wave from the second inclined surface has the predetermined strength or higher.

5. The radio wave reflector according to claim 4, wherein an inclination angle of the first inclined surface with respect to the first flat surface and an inclination angle of the second inclined surface with respect to the first flat surface are equal to each other.

6. The radio wave reflector according to claim 1, wherein the area of the first flat surface and the area of the first inclined surface are equal to each other.

7. The radio wave reflector according to claim 6, wherein in the angular distribution of the reflected wave with respect to the normal passing through the center of the first flat surface, the first inclined surface is inclined with respect to the first flat surface so that an overlap is formed between an angular range in which the strength of the reflected wave from the first flat surface becomes a half of the maximum value and an angular range in which the strength of the reflected wave from the first inclined surface becomes a half of the maximum value.

8. The radio wave reflector according to claim 2, further comprising:
a second inclined surface that is connected to at least part of the outer edge of the first flat surface, is inclined with respect to the first flat surface, and reflects a radio wave;
a third inclined surface that is connected to at least part of the outer edge of the first flat surface, is inclined with respect to the first flat surface, and reflects a radio wave; and
a fourth inclined surface that is connected to at least part of the outer edge of the first flat surface, is inclined with respect to the first flat surface, and reflects a radio wave; wherein
the first inclined surface, the third inclined surface, the second inclined surface, and the fourth inclined surface are in a trapezoidal shape and are placed in an order of the first inclined surface, the third inclined surface, the second inclined surface, and the fourth inclined surface, enclosing four outer sides of the rectangular shape of the first flat surface.

9. The radio wave reflector according to claim 8, wherein:
an inclination angle of the first inclined surface with respect to the first flat surface and an inclination angle of the second inclined surface with respect to the first flat surface are equal to each other;
an inclination angle of the third inclined surface with respect to the first flat surface and an inclination angle of the fourth inclined surface with respect to the first flat surface are equal to each other; and
the inclination angle of the first inclined surface with respect to the first flat surface and the inclination angle of the third inclined surface with respect to the first flat surface are different from each other.

10. The radio wave reflector according to claim 8, wherein:
an inclination angle of the first inclined surface with respect to the first flat surface and an inclination angle of the second inclined surface with respect to the first flat surface are equal to each other;
an inclination angle of the third inclined surface with respect to the first flat surface and an inclination angle of the fourth inclined surface with respect to the first flat surface are equal to each other; and
the inclination angle of the first inclined surface with respect to the first flat surface and the inclination angle of the third inclined surface with respect to the first flat surface are equal to each other.

11. The radio wave reflector according to claim 8, wherein the area of the first flat surface, the area of the first inclined surface, an area of the second inclined surface, an area of the third inclined surface, and an area of the fourth inclined surface are equal to one another.

12. The radio wave reflector according to claim 11, wherein in the angular distribution of the reflected wave with respect to the normal passing through the center of the first flat surface:
the first inclined surface is inclined with respect to the first flat surface so that an overlap is formed between an angular range in which the strength of the reflected wave from the first flat surface becomes a half of the maximum value and an angular range in which the strength of the reflected wave from the first inclined surface becomes a half of the maximum value;
the second inclined surface is inclined with respect to the first flat surface so that an overlap is formed between the angular range in which the strength of the reflected wave from the first flat surface becomes a half of the maximum value and an angular range in which a strength of a reflected wave from the second inclined surface becomes a half of a maximum value;
the third inclined surface is inclined with respect to the first flat surface so that an overlap is formed between the angular range in which the strength of the reflected wave from the first flat surface becomes a half of the maximum value and an angular range in which a strength of a reflected wave from the third inclined surface becomes a half of a maximum value; and
the fourth inclined surface is inclined with respect to the first flat surface so that an overlap is formed between the angular range in which the strength of the reflected wave from the first flat surface becomes a half of the maximum value and an angular range in which a strength of a reflected wave from the fourth inclined surface becomes a half of a maximum value.

13. The radio wave reflector according to claim 1, wherein the first flat surface has any of a polygonal shape, a circular shape, and an elliptical shape, or has a shape in which an outer edge of the first flat surface is equivalent to at least part of a polygonal shape, a circular shape, or an elliptical shape.

14. The radio wave reflector according to claim 13, wherein the first inclined surface is an inclined surface that encloses all outer edges of the first flat surface.
